(19) United States
(12) Patent Application Publication
(10) Pub. No.: US 2025/0372770 A1
(43) Pub. Date: Dec. 4, 2025

(54) Fuel Cell System and Method of Controlling Same

(71) Applicants: Hyundai Motor Company, Seoul (KR); Kia Corporation, Seoul (KR)

(72) Inventors: Joo Yeon Kim, Hanam-Si (KR); Jae Ho Han, Suwon-Si (KR)

(21) Appl. No.: 18/948,079

(22) Filed: Nov. 14, 2024

(30) Foreign Application Priority Data
Jun. 2, 2024 (KR) 10-2024-0058574

(51) Int. Cl. H01M 16/00; H01M 8/04858; H01M 10/42; H01M 10/48

(52) U.S. Cl. CPC H01M 16/006; H01M 8/0494; H01M 10/425; H01M 10/48; H01M 2010/4271; H01M 2220/20; H01M 2250/20

(57) ABSTRACT

A fuel cell system includes a battery and a fuel cell stack, each configured to output electrical energy to satisfy total final required power, and a controller configured to perform a method of controlling the fuel cell system. The controller may be configured to calculate a required power proportion of the fuel cell stack to satisfy the final required power, to calculate a final power proportion of the stack by calibrating the required power proportion of the fuel cell stack using a power adjustment value depending on a state of health (SoH) of the fuel cell stack, and to control power generation of the fuel cell stack according to the calculated final power proportion.

### CROSS-REFERENCE TO RELATED APPLICATION

This application claims priority from Korean Patent Application No. 10-2024-0058574, filed on May 2, 2024 in the Korean Intellectual Property Office, the disclosure of which is incorporated herein by reference in its entirety.

### TECHNICAL FIELD

The present disclosure relates to a fuel cell system and a method of controlling the same to optimize power distribution for an entire fuel cell vehicle and manage an SoH in advance by applying a control technique for previously calibrating/limiting a required power amount of a stack in the fuel cell vehicle and preventing continuous SoH decline by using SoH information in order to improve power errors caused by decrease in stack power of the fuel cell vehicle or the like.

### BACKGROUND

A fuel cell is a device that receives hydrogen and air from the outside and generates electrical energy through an electrochemical reaction inside a fuel cell stack and can be used as a power source in various fields such as fuel cell vehicles (FCEV) and fuel cells for power generation.

A fuel cell system may include a fuel cell stack in which multiple fuel cells used as a power source are stacked, a fuel supply system that supplies hydrogen or the like to the fuel cell stack as a fuel, an air supply system that supplies oxygen, which is an oxidizing agent necessary for electrochemical reactions, a water and heat management system that controls the temperature of the fuel cell stack, and the like.

The fuel supply system may depressurize the compressed hydrogen in a hydrogen tank and supply the same to an anode of the fuel cell stack, and the air supply system may operate an air compressor to supply compressed external air to a cathode of the fuel cell stack.

When hydrogen is supplied to the anode of the fuel cell stack and oxygen is supplied to the cathode, hydrogen ions are separated in the anode through a catalytic reaction. The separated hydrogen ions are transferred to the cathode through an electrolyte membrane, and an electrochemical reaction of the hydrogen ions separated from the anode, electrons, and oxygen occurs in the cathode, and accordingly electrical energy can be obtained. Electrochemical oxidation of hydrogen occurs in the anode, electrochemical reduction of oxygen occurs in the cathode, electricity and heat are generated due to the movement of electrons generated at this time, and water vapor or water is generated through a chemical reaction of hydrogen and oxygen combining.

An exhaust device may be provided to discharge by-products such as water vapor, water and heat, and unreacted hydrogen and oxygen generated during the electrical energy generation process in the fuel cell stack, and gases such as water vapor, hydrogen and oxygen are discharged into the atmosphere through an exhaust passage.

Electrochemical reactions that occur in a fuel cell are represented by reaction formulas as follows.

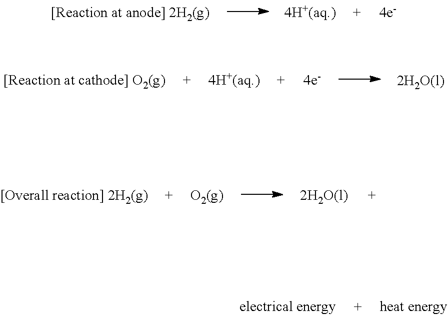

As represented by the above reaction formulas, hydrogen molecules are decomposed in the anode to generate 4 hydrogen ions and 4 electrons. The electrons move through an external circuit to generate current (electrical energy), the hydrogen ions move to the cathode through an electrolyte membrane to cause a cathode reaction, and water and heat are generated as by-products of the electrochemical reactions.

From the perspective of vehicles using fuel cells, a fuel cell vehicle may include two power sources composed of an energy storage device such as a high-voltage battery and a stack, and the efficiency and durability of the fuel cell vehicle can be improved by appropriately controlling the usage of the two power sources. Here, if a relatively large amount of stack power is used, energy efficiency decrease and accelerated stack durability deterioration due to increased usage of hydrogen energy may lead to performance decline and a shortened parts replacement cycle. If a large amount of battery power is used, limitations in battery capacity may cause problems in the durability of the battery due to limitations in motoring or regenerative braking and frequent charging and discharging.

To solve this, a method of minimizing unnecessary stack use and battery charging and discharging by determining a ratio of stack required power to battery required power in consideration of power required for operation and the battery SoC may be considered. However, when power performance decline arises due to deterioration of the durability of the stack, the actual power (feedback) of the stack corresponding to the determined stack required power (target) may not be generated, or response may be delayed, resulting in overall power decrease and a shaking of the vehicle. If the above situation continuously occurs, it is expected that errors in feedback power control will increase.

The matters described as background technology above are only for the purpose of improving understanding of the background of the present disclosure and should not be taken as recognition that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a fuel cell system. A fuel cell system may comprise: a battery configured to output a first electrical energy; a fuel cell stack configured to output a second electrical energy, wherein a total of the first electrical energy and the second electrical energy satisfies a final required power; and a controller. The controller may be configured to: determine a required power proportion of the fuel cell stack to satisfy the final required power; determine a final power proportion of the fuel cell stack by calibrating, based on a power adjustment value depending on a state of health (SoH) of the fuel cell stack, the required power proportion of the fuel cell stack; and control, based on the determined final power proportion, power generation of the fuel cell stack.

Also, or alternatively, a method (e.g., performed by the controller) may comprise: determining, by a controller of a fuel cell system comprising a fuel cell stack and a battery, a required power proportion of the fuel cell stack to satisfy, with a power proportion from the battery, a final required power; determining, by the controller based on a state of health (SoH) of the fuel cell stack, a power adjustment value; determining, by the controller, a final power proportion of the fuel cell stack by calibrating the required power proportion of the fuel cell stack based on the determined power adjustment value; and controlling, by the controller and based on the final power proportion, power generation by the fuel cell stack.

These and other features and advantages are described in greater detail below.

### BRIEF DESCRIPTION OF THE DRAWINGS

FIG. 1 is a configuration diagram of a fuel cell system according to an example of the present disclosure.

FIG. 2 is a diagram illustrating state-of-health (SoH) ranges of a fuel cell stack of the fuel cell system according to an example of the present disclosure.

FIG. 3 and FIG. 4 are graphs showing the performance according to the SoH of the fuel cell stack of the fuel cell system according to an example of the present disclosure.

FIG. 5 is a flowchart of a method of controlling the fuel cell system according to an example of the present disclosure.

FIG. 6, FIG. 7, and FIG. 8 are diagrams for describing a power weighting coefficient for determining a power adjustment value according to an example of the present disclosure.

FIG. 9, FIG. 10, and FIG. 11 are diagrams for describing a compensation coefficient for determining a power adjustment value according to an example of the present disclosure.

### DETAILED DESCRIPTION

Hereinafter, examples disclosed in the present disclosure will be described in detail with reference to the attached drawings. However, identical or similar components will be assigned the same reference numeral, and redundant descriptions thereof will be omitted.

In the following description of the examples disclosed in the present disclosure, a detailed description of known functions and configurations incorporated herein will be omitted when it may obscure the subject matter of the present disclosure. Also, or alternatively, the accompanying drawings are provided only for ease of understanding of the examples disclosed in the present disclosure, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

An element described in the singular form is intended to include a plurality of elements unless the context clearly indicates otherwise.

In the present disclosure, it will be further understood that the term “comprise” or “include” specifies the presence of a stated feature, figure, step, operation, component, part or combination thereof, but does not preclude the presence or addition of one or more other features, figures, steps, operations, components, or combinations thereof.

The suffixes “module” and “unit” of elements used in the following description are used for convenience of description and thus can be used interchangeably and do not have any distinguishable meanings or functions.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

A controller may include a communication device that communicates with other controllers and/or sensors in order to control functions of the controller, a memory in which an operating system, logic instructions, input/output information, etc. are stored, and one or more processors that perform determination, computations, and decisions necessary to control the functions.

The present disclosure is applicable to any system that uses a fuel cell as a power source along with a battery. The present disclosure is also applicable to vehicles or power generation systems.

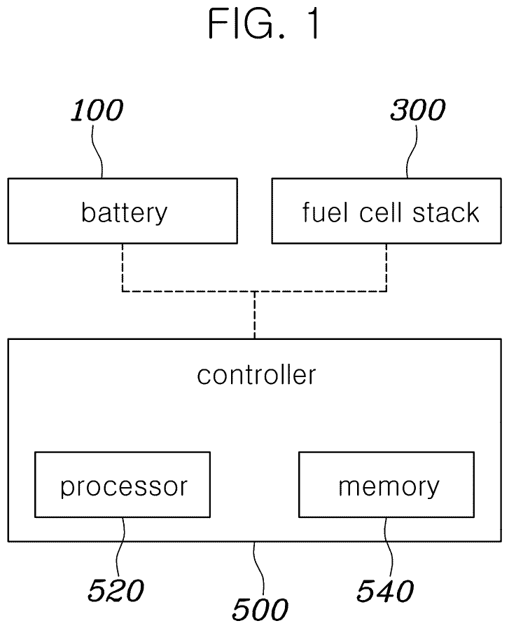

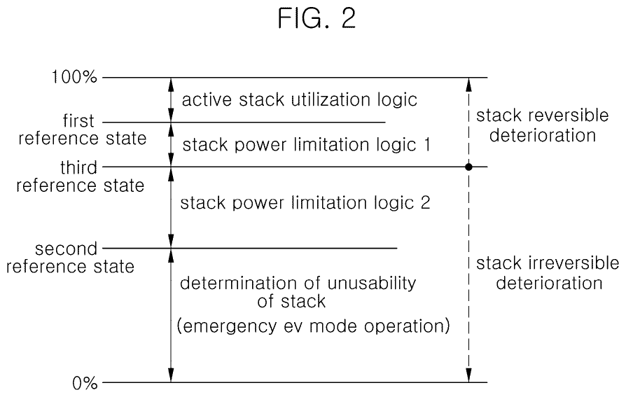

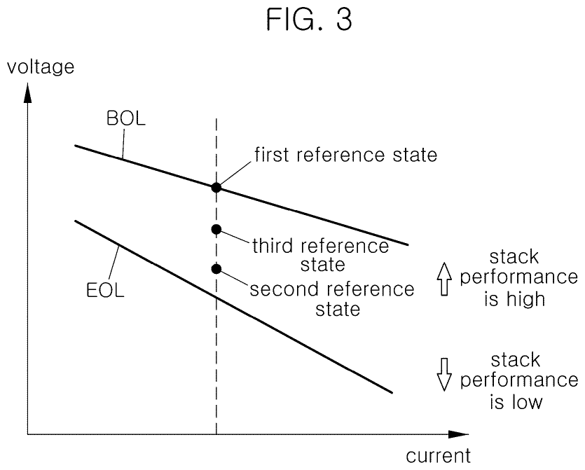

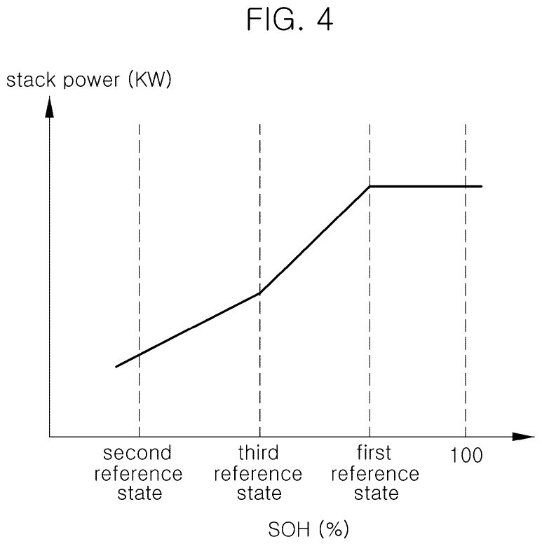

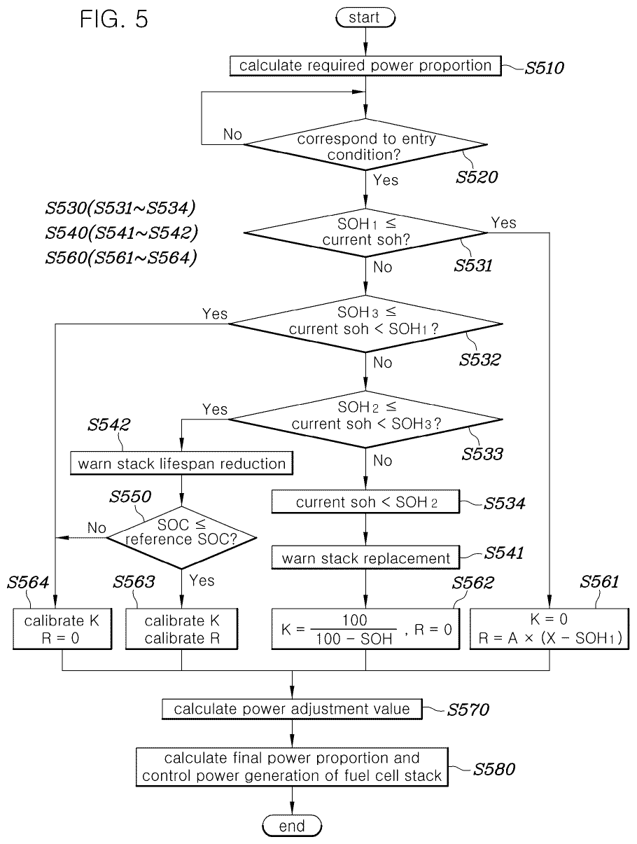

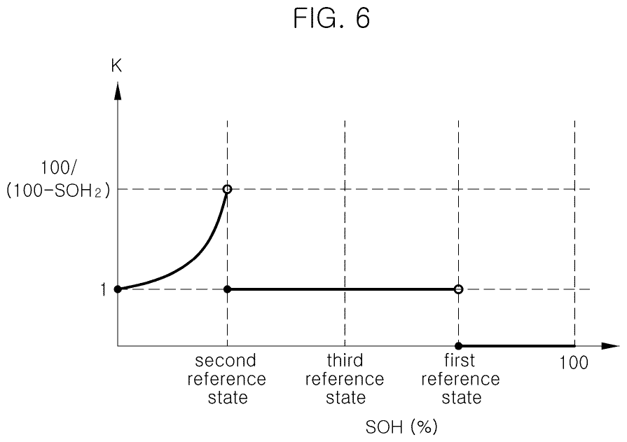

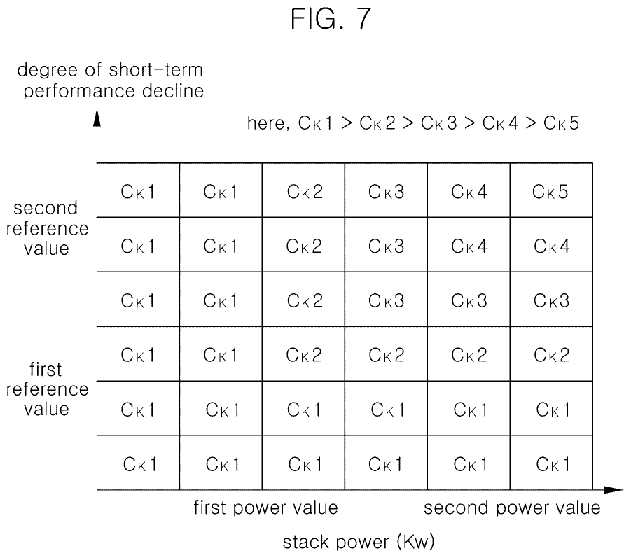

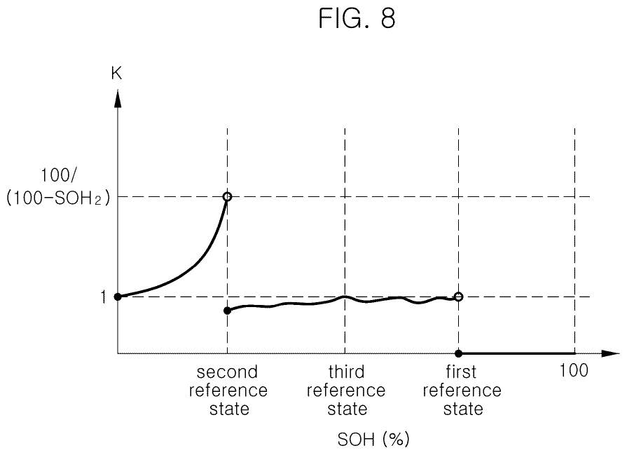

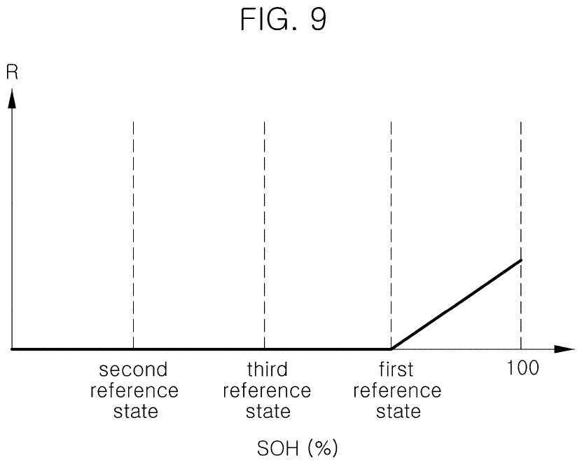

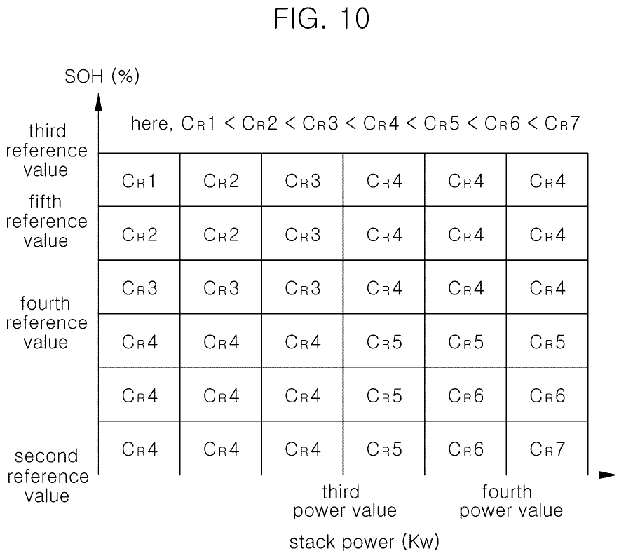

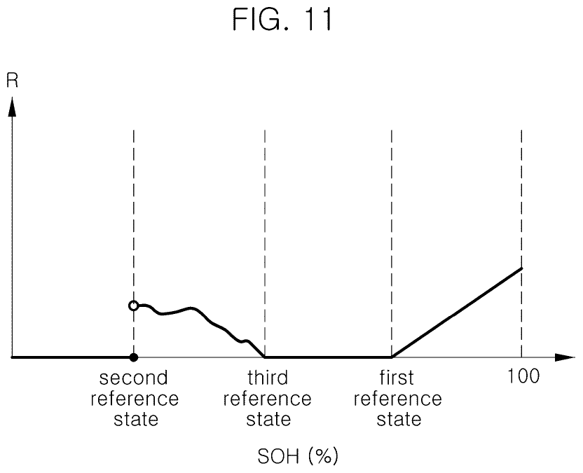

FIG. 1 is a configuration diagram of a fuel cell system according to an example of the present disclosure, FIG. 2 is a diagram illustrating state-of-health (SoH) ranges of a fuel cell stack of the fuel cell system according to an example of the present disclosure, FIG. 3 and FIG. 4 are graphs showing the performance according to the SoH of the fuel cell stack of the fuel cell system according to an example of the present disclosure, FIG. 5 is a flowchart of a method of controlling the fuel cell system according to an example of the present disclosure, FIG. 6 to FIG. 8 are diagrams for describing a power weighting coefficient for determining a power adjustment value according to an example of the present disclosure, and FIG. 9 to FIG. 11 are diagrams for describing a compensation coefficient for determining a power adjustment value according to an example of the present disclosure.

First, the fuel cell system of the present disclosure will be briefly described with reference to FIG. 1.

FIG. 1 is a configuration diagram of the fuel cell system according to an example of the present disclosure. The fuel cell system of the present disclosure uses a fuel cell stack 300 and a battery 100 as power sources. The fuel cell stack 300 and the battery 100 are used together as power sources for operating a vehicle or the like. The battery 100 can be charged through power generation of the fuel cell stack 300, and may also be charged through regenerative braking.

Therefore, total power required by the entire system of the vehicle or the like is divided into (e.g., includes) power to be provided by the fuel cell stack 300 and power to be provided by the battery 100. The amount of power to be generated by the fuel cell stack 300 is determined in consideration of the state of charge (SoC) of the battery 100, and the like. In the case of the battery 100, charging through regeneration in addition, or alternatively, to charging via the fuel cell stack 300 generally (e.g., always) occurs. Thus it is necessary to manage the SoC in preparation for regenerative charging, and based on this, the amount of power to be generated by the fuel cell stack 300 may be determined.

A controller 500 controls charging/discharging and power generation of the battery 100 and the fuel cell stack 300. The controller 500 may be comprised of a processor 520 that performs computations for control and a memory 540 in which data and formulas referred to for computation are stored.

The fuel cell system according to the present disclosure includes the battery 100 and the fuel cell stack 300 that output electrical energy to satisfy final required power, and the controller 500 that calculates a required power proportion of the fuel cell stack in order to satisfy the final required power, calibrates the required power proportion of the fuel cell stack using a power adjustment value that varies depending on the SoH of the fuel cell stack to calculate a final power proportion of the fuel cell stack, and controls power generation of the fuel cell stack according to the final power proportion.

The entire system (such as a vehicle) has a final required power. The final required power is met by a total electrical energy produced by the battery 100 and the fuel cell stack 300. In the battery 100 and the fuel cell stack 300, the amount of power to be generated by the fuel cell stack 300 is calculated based on the required power proportion of the fuel cell stack 300 relative to the final required power. The controller 500 may control power generation by the fuel cell stack according to the calculated required power proportion of the fuel cell stack.

As described herein, the fuel cell stack 300 deteriorates over time, which can be determined through the state of health (SoH). When the SoH has declined, the power generation efficiency is reduced even if the same amount of air and hydrogen is supplied. Accordingly, the controller 500 needs to perform calibration if the SoH of the fuel cell stack 300 has declined to control the fuel cell stack 300 such that the fuel cell stack 300 can generate more power, and thus substantially necessary energy can be produced. Otherwise, the final power required by the system will not be satisfied.

Methods of calculating the SoH through accumulated data while measuring the current of the fuel cell stack 300 have been proposed. The SoH of the fuel cell stack 300 may be calculated through various methods, and the present disclosure is not limited to any one calculation method.

The controller 500 may calculate a power adjustment value that varies depending on the calculated SoH of the fuel cell stack 300. For example, if the performance of the fuel cell stack 300 has significantly decreased, the controller 500 may calculate the power adjustment value such that the performance of the fuel cell stack 300 can be further calibrated. The controller 500 may calculate the final power proportion of the fuel cell stack 300 by calibrating the required power proportion of the fuel cell stack 300 using the calculated power adjustment value. Also, or alternatively, the controller 500 controls power generation of the fuel cell stack 300 according to the calculated final power proportion.

Through the process described herein, the power proportions of the fuel cell stack 300 and the battery 100 can be readjusted and determined by using the performance indicator (e.g., SoH) of the fuel cell stack as a factor determining the ratio of the required power of the fuel cell stack to the required power of the battery, and preemptively predicting a decrease in available power of the fuel cell stack.

Also, or alternatively, it is possible to prevent a decrease in vehicle driving power and unexpected vehicle shaking in a situation where the performance of the fuel cell stack 300 declines from the prospective of overall vehicle energy, and depending on the SoH of the fuel cell stack 300, control of actively using or compensating for the fuel cell stack 300 can be performed, and accordingly, utilization of the fuel cell stack 300 in the fuel cell system can be maximized.

In order to secure optimal efficiency and performance by providing a more detailed control process of the controller 500, SoH ranges of the fuel cell stack 300 may be defined as shown in FIG. 2 in one example of the present disclosure.

FIG. 2 is a diagram illustrating SoH ranges of the fuel cell stack of the fuel cell system according to an example of the present disclosure.

Referring to FIG. 2, power control ranges of the fuel cell stack 300 may be classified according to the SoH of the fuel cell stack 300, and each range is defined as follows.

[Range 1] 100≥SoH (%)>first reference state: Range 1 is a range in which the power performance of the fuel cell stack 300 may be maintained without decline (e.g., even if the SoH of the fuel cell stack 300 declines). The fuel cell stack 300 can be actively utilized. In this case, active stack utilization logic may be applied.

[Range 2] Second reference state≥SoH (%)>0: Range 2 is a range in which the SoH of the fuel cell stack 300 has decreased to equal to or less than a certain level (second reference state) at which the fuel cell stack 300 cannot be used (fuel cell stack power=0). In this case, the fuel cell system can be operated only with the battery 100. This range may correspond to a range in which it is determined that the fuel cell stack 300 cannot be used.

For example, the range between the first reference state and the second reference state may be divided into a plurality of ranges depending on the degree of deterioration of the fuel cell stack 300, and in one example of the present disclosure, the range may be divided into a plurality of ranges according to the degree of deterioration of the fuel cell stack 300 based on a third first reference state that falls between the first reference state and the second reference state as follows.

[Range 3] First reference state≥SoH (%)>third reference state: Range 3 may be a range in which the SoH of the fuel cell stack 300 has decreased to equal to or less than a certain level (first reference state) and thus power performance decline of the fuel cell stack 300 begins to appear, but is still above a third reference state. The maximum power of the fuel cell stack 300 cannot be produced in this range, so the power of the fuel cell stack 300 may need to be limited This range may correspond to a range to which stack power limitation logic 1 is applied.

[Range 4] Third reference state≥SoH (%)>second reference state: Range 4 may be a range in which the SoH of the fuel cell stack 300 decreases equal to or less than a certain level (third reference state), and SoH decline and power decrease of the fuel cell stack 300 tends to accelerate and/or be greater compared to [range 3] described herein. In this range, stack power may be limited more (e.g., more actively) than in [range 3] described herein, and this range may correspond to a range to which stack power limitation logic 2 is applied.

As described herein, the SoH standard defining each range according to an example of the present disclosure may be divided into the first reference state, the second reference state, and the third reference state. Thereamong, the first reference state may refer to a point in time when power decreases due to decline of the SoH of the fuel cell stack 300. The second reference state is a lower state than the first reference state and may refer to a point in time when the maximum power of the fuel cell stack 300 falls equal to or less than a certain level (which may vary depending on the fuel cell stack and battery capacity/motor specifications). In other words, the second reference state may mean a point in time when the fuel cell stack power falls equal to or less than a certain level, making it difficult to handle the load of the entire system even if the fuel cell stack power is combined with the battery power. The third reference state is lower than the first reference state but higher than the second reference state, and may refer to a point in time when it is determined whether the fuel cell stack 300 enters an irreversible deterioration state in which durability recovery is difficult.

Here, the SoH may fall into a reversible deterioration range and/or an irreversible deterioration range of the fuel cell stack 300, distinguished based on the third reference state. There is a point in time (limitation point) at which the performance of the fuel cell stack 300 significantly declines and thus it is difficult to improve the performance if a change in the SoH according to the operation method decreases equal to or less than a certain level. After passing the third reference state, it may be necessary to minimize the use of the fuel cell stack 300 and/or display a warning light to cause maintenance to be performed.

Such a long-term SoH indicator is an average indicator showing the performance of the fuel cell stack 300. The present disclosure may determine the major flow of the current state of the fuel cell stack 300 through the indicator, determine entry into the range corresponding to defined logic (active stack utilization logic/stack power limitation logic/logic of determination of unusability of the stack), and establish an appropriate driving strategy.

Meanwhile, in order to prevent frequent repetition of entry/release at the time of changing logic according to the SoH range of the fuel cell stack 300, hysteresis for entry/release for each range may be provided to increase the stability of the logic and system.

The first, second, and third reference states described herein are illustrative and the present disclosure is not necessarily limited thereto. For example, the first, second, and third reference states may be determined based on tests and the like for each specification of the fuel cell system and/or the fuel cell stack.

The SoH ranges classified as above can be understood through the graphs of FIG. 3 and FIG. 4. FIG. 3 and FIG. 4 are graphs showing the performance according to the SoH of the fuel cell stack of the fuel cell system according to an example of the present disclosure. Referring to this, it can be ascertained that each range can be defined as follows.

[Range 1] 100≥SoH (%)>first reference state: a state in which the performance of the fuel cell stack 300 is close to BoL (Beginning of Life) and can be actively utilized, and the fuel cell stack 300 can produce maximum power. As the durability of the fuel cell stack 300 decreases, the SoH may gradually decrease from 100% to the first reference state.

[Range 2] Second reference state≥SoH (%)>0: a state in which the lifespan of the fuel cell stack 300 has reached the limit thereof, and thus temporary operation using only the battery 100 is possible. In this case, system operation may be significantly limited.

[Range 3] First reference state≥SoH (%)>third reference state: a state at which the durability of the fuel cell stack 300 falls equal to or less than a certain level, the SoH gradually decreases and this appears as a numerical value, which may appear as a decrease in the power of the fuel cell stack 300. In this range, the actual power may decrease compared to required power of the fuel cell stack 300, and thus power errors may be accumulated.

[Range 4] Third reference state≥SoH (%)>second reference state: a state in which the SoH of the fuel cell stack 300 significantly declines, and thus errors in the actual power of the fuel cell stack 300 compared to the required power may be increased. Ultimately, even if the power of the battery 100 and the power of the fuel cell stack 300 are combined, the required power of the entire system may not be reached in this range.

For each range according to the aforementioned SoH, the controller 500 may calibrate the required power proportion of the fuel cell stack 300 differently.

The SoH is a means capable of indicating the performance of the fuel cell stack 300, and it is possible to predict the current state of the fuel cell stack 300 based on the SoH. However, in order to accurately predict the current state, reliability of the SoH can be secured only if sufficient data is secured in accordance with a certain level of operation frequency and predefined specific ranges and power conditions. In the present disclosure, since the required power of the fuel cell stack 300 depending on the SoH is controlled as a proportion, direct reflection of frequent fluctuations (noise) of the SoH as a control factor may cause the fuel cell stack voltage and the voltage of a high voltage stage of the entire system to fluctuate. This may affect the durability and operations of components connected to the high voltage stage, and thus a pre-entry condition is required to clearly determine that the SoH has declined and perform a logic.

Accordingly, the controller 500 may calibrate the required power proportion of the fuel cell stack 300 if a change rate of the SoH of the fuel cell stack 300 for each range is greater than or equal to a preset reference change rate.

By way of example, the controller 500 may calibrate the required power proportion of the fuel cell stack 300 if the following condition is satisfied.

$$\vert \frac{{SoH}_{1} + ⋯ + {SoH}_{n}}{n} - \frac{( {SoH}_{n + 1} + ⋯ + {SoH}_{2 n + 1} )}{n} \vert > m$$

As above, a certain number n of pieces of data is secured and averaged to ensure reliability of the data (removal of determination noise), and if a change in the average value occurs more than a reference change rate m, entry into the logic of limiting power of the fuel cell stack 300 depending on the SoH is determined. If the condition is not satisfied, it is determined that 1) sufficient data has not been secured, and 2) there is insignificant or no change in the SoH, and entry into a logic is not performed. Here, n and m may be adjusted according to a change rate (slope) of each range of the SoH. For example, referring to the previous definitions, since a change rate in range 3 (first reference state>SoH≥third reference state) is greater than a change rage in range 4 (third reference state>SoH≥second reference state), it is necessary to set n to be smaller in range 3 to rapidly determine changes in the SoH and decide to enter a logic.

FIG. 5 is a flowchart of a method of controlling a fuel cell system according to an example of the present disclosure. The control process of the controller 500 according to an example of the present disclosure will be described in more detail with reference to FIG. 5. For convenience, FIG. 5 is described by way of an example in which the steps are performed by a processor circuit of the controller 500. One, some, or all steps of the example method of FIG. 5, or portions thereof, may be performed by one or more other circuits. One or some, steps of the example method of FIG. 5 may be omitted, performed in other orders, and/or otherwise modified, and/or one or more additional steps may be added.

The method of controlling a fuel cell system according to an example of the present disclosure is a method of controlling a fuel cell system including the battery 100, the fuel cell stack 300, and the controller 500, and may include step S510 in which the controller 500 calculates a required power proportion of the fuel cell stack 300 to satisfy final required power, step S570 in which the controller 500 calculates a power adjustment value that varies depending on the SoH of the fuel cell stack 300, step S580 in which the controller 500 calculates a final power proportion of the fuel cell stack 300 by calibrating the required power proportion of the fuel cell stack 300 according to the calculated power adjustment value, and step S580 in which the controller 500 controls power generation of the fuel cell stack 300 according to the calculated final power proportion.

The controller 500 may calibrate the required power proportion by multiplying the required power proportion of the fuel cell stack 300 by the power adjustment value and calculate the final power proportion based on the calibrated required power proportion. The controller 500 may determine whether the entry condition is met prior to calibrating the required power proportion (S520). For example, as described above, the controller 500 may calibrate the required power proportion of the fuel cell stack 300 if a change rate of the SoH of the fuel cell stack 300 for each range is greater than or equal to a preset reference change rate.

The power adjustment value may vary depending on the SoH of the fuel cell stack 300, and may vary. Also, or alternatively, the power adjustment value may vary in consideration of at least one of the amount of power generated by the fuel cell stack 300 and the degrees of short-term performance decline of the fuel cell stack 300. For example, the power adjustment value may vary based on a power weighting coefficient K and a compensation coefficient R, which vary depending on the SoH of the fuel cell stack 300 and may be determined using the formula below.

$$Power adjustment value = 1 - power weighting coefficient \times ( 1 - \frac{SoH}{100} ) + compensation coefficient$$

The present disclosure proposes the above formula in order to determine the power proportion of the fuel cell stack 300 depending on the SoH of the fuel cell stack 300. In this formula, a power adjustment ratio according to the SoH of the fuel cell stack 300 is added to the power proportions of the battery 100 and the fuel cell stack 300 such that SoH information of the fuel cell stack 300 is reflected in the power proportions of the battery 100 and the fuel cell stack 300 (power proportion determination method based on overall system required power and battery SoC standard). This is for the purpose of establishing an operation strategy depending on the SoH of the fuel cell stack 300 to allow the system to utilize the performance of the fuel cell stack 300 to the maximum.

The power adjustment value depending on the SoH of the fuel cell stack 300 is determined based on the SoH (percentage), and the power adjustment value depending on the SoH is closer to 1 as the SoH is higher (closer to 100) and is closer to 0 as the SoH is lower (closer to 0). The power weighting coefficient K may be a power weight factor according to the performance of the fuel cell stack 300 and may mean a power weight depending on the state of the fuel cell stack 300, which is set because the power of the fuel cell stack 300 does not change linearly if the state of the fuel cell stack 300 changes.

The compensation coefficient R is an offset compensation value and may be used to increase the usability of the fuel cell stack 300 Also, or alternatively to the power adjustment ratio determined previously (if the compensation coefficient is not applied, the maximum power adjustment ratio according to the SoH is 1).

The controller 500 according to an example of the present disclosure may determine the SoH of the fuel cell stack 300 (S530) and determine the power weighting coefficient K and the compensation coefficient R according to the determined SoH of the fuel cell stack 300 (S560).

Also, or alternatively, it is possible to finally reflect the power performance according to the SoH of the fuel cell stack 300 by reflecting the power adjustment value calculated based on the power weighting coefficient K and the compensation coefficient R determined as above in the initially calculated required power proportion of the fuel cell stack.

Hereinafter, the process of calculating the power adjustment value according to an example of the present disclosure will be described in detail with reference to FIG. 6 to FIG. 11.

FIG. 6 to FIG. 8 are diagrams for describing the power weighting coefficients for determining the power adjustment value according to an example of the present disclosure, and FIG. 9 to FIG. 11 are diagrams for describing the compensation coefficient for determining the power adjustment value according to an example of the present disclosure.

First, the power weighting coefficient according to an example of the present disclosure will be described with reference to FIG. 5 and FIG. 6 to FIG. 8.

Referring to FIG. 5 and FIG. 6, the power weighting coefficient K may be 0 if the SoH of the fuel cell stack 300 is greater than or equal to the preset first reference state SoH₁ (Yes in S531, S561). A case where the SoH is greater than or equal to the first reference state SoH₁ may corresponds to a range in which the fuel cell stack 300 is actively utilized, and the performance of the fuel cell stack 300 will not be a major problem (e.g., even if the fuel cell stack 300 is used 100%) because the SoH of the fuel cell stack 300 is high. The power weighting coefficient K is set to 0 and the power adjustment value is fixed to 1 (in this case, the compensation coefficient is assumed to be 0), and accordingly, the final power proportion may be the same as the previously proposed required power proportion.

Also, or alternatively, the power weighting coefficient (K) may be determined according to the formula below if the SoH of the fuel cell stack 300 is equal to or less than the second reference state SoH₂, which is preset to be lower than the first reference state SoH₁ (S534 and S562).

$$P ower weighting coefficient = \frac{100}{100 - SoH}$$

Prior to determining the power weighting coefficient K, if the SoH of the fuel cell stack 300 is equal to or less than the second reference state SoH₂, the controller 500 may issue a warning regarding fuel cell stack replacement to prompt maintenance (S541). If the SoH is equal to or less than the second reference state SoH₂, it corresponds to a range in which the fuel cell stack 300 is determined to be unusable, and thus the SoH of the fuel cell stack 300 is determined to be abnormal and the power of the fuel cell stack 300 may be controlled to be 0. Accordingly, by setting the power weighting coefficient K as represented by the above formula, the power adjustment value depending on the SoH can be determined to be 0, and accordingly, not only the required power proportion but also the final power proportion can be determined to be 0.

The first and second reference states are as described in detail with reference to FIG. 2.

Also, or alternatively, the power weighting coefficient K may be 1 if the SoH of the fuel cell stack 300 falls between the preset first reference state SoH1 and the second reference state SoH₂ which is preset to be lower than the first reference state. The range corresponding to this case is a range in which the power limitation logic of the fuel cell stack 300 is applied. Since the performance of the fuel cell stack 300 declines in this range, the power of the fuel cell stack 300 may be determined according to the SoH. Here, the power weighting coefficient K may be set to 1 and thus the power adjustment value depending on the SoH may be determined as SoH/100, and an adjustment proportion that is proportional to the SoH may be reflected in the final power proportion.

However, this is a value determined based on the long-term performance of the fuel cell stack 300, and although long-term factors are important during actual operation of the fuel cell stack 300, it may also be necessary to consider the short-term performance of the fuel cell stack 300.

Accordingly, the power weighting coefficient K according to an example of the present disclosure may be varied based on 1 (e.g., varied relative to 1/from 1/around 1) if the SoH of the fuel cell stack 300 is between the first reference state SoH₁ and the second reference state SoH₂ (Yes in S532, Yes in S533, S563, and S564). For example, in this case, the power weighting coefficient K may be varied based on 1 by reflecting a first calibration value determined according to the power amount of the fuel cell stack 300 or the degree of short-term performance decline of the fuel cell stack 300.

FIG. 7 shows data regarding the first calibration value for compensating for the power weighting coefficient. In the present disclosure, the instantaneous frequency of a cell voltage decline phenomenon in which a voltage of some cells, among a plurality of cells included in the fuel cell stack 300, becomes lower than that of remaining cells is reflected in a stack performance indicator which can check the performance of the fuel cell stack 300. For example, the instantaneous frequency of a cell voltage decline phenomenon may be determined (e.g., by the stack performance indicator) based on a cell voltage ratio (RV), and an RV indicator may be utilized in order to determine the power weighting coefficient K in consideration of the short-term performance state of the fuel cell stack 300 in addition, or alternatively, to the long-term performance state of the fuel cell stack 300. This is an example and the present disclosure is not necessarily limited thereto, and it is also possible to use a DV value instead of RV. RV is a cell voltage ratio and indicates the ratio of a minimum cell voltage to the overall average cell voltage, and DV is a cell voltage deviation and indicates a deviation between the overall average cell voltage and the minimum cell voltage.

Meanwhile, RV is a numerical value representing an indicator of the degree to which a reference value has decreased based on all cells of the fuel cell stack 300, and by using this value, the short-term SoH of the fuel cell stack 300 can be reflected in the indicator. If the reference value of some cells continues to decrease, this means that the durability of the corresponding cells is physically declining, which may mean the short-term performance decline of the fuel cell stack 300.

Referring to FIG. 7, [the first calibration value depending on RV state] is determined based on whether the number of times the RV falls equal to or less than a certain value (criterion for determining performance decline) is a certain number of times in a certain stack power range based on a certain driving cycle (based on securing a sufficient database). However, since the range in which the power weighting coefficient K changes in proportion to the long-term SoH is a range between the first reference state and the second reference state, the short-term performance of the fuel cell stack 300 can be determined in the range.

By using this first calibration value, it is possible to determine physical performance decline of the fuel cell stack 300 and preemptively reflect the same in the strategy by reflecting the short-term performance of the fuel cell stack 300 in the indicator Also, or alternatively to the long-term performance of the fuel cell stack 300.

The first calibration value may be applied as a derating factor in determining the power weighting coefficient K. That is, if the first calibration value is 1, this indicates satisfactory physical performance with no instantaneous the cell voltage decline phenomenon, and the state may be determined by 0 to 1. As shown in FIG. 7, each of Cₖ₁ to Cₖ₅ may be the first calibration value classified depending on the power and the degree of decline in the short-term performance of the fuel cell stack 300. Also, or alternatively, the first calibration value may decrease as the power amount or the degree of decline in the short-term performance of the fuel cell stack 300 increases, and thus the relationship of Cₖ₁>Cₖ₂>Cₖ₃>Cₖ₄>Cₖ₅ may be established.

For example, if the power of the fuel cell stack 300 is low, the total power consumption itself is small and the deviation is also small, and thus the first calibration value may be set to Cₖ₁ (e.g., 1) because determination of the number of RV decreases is unclear. Also, or alternatively, if the power of the fuel cell stack 300 is high and the number of RV decreases is small, the cell performance is uniform and satisfactory, and thus the first calibration value may be set to Cₖ₁ (e.g., 1). Also, or alternatively, if the number of RV decreases is large while the power of the fuel cell stack 300 is high, this means that operation is performed while the performance of a specific cell continues to decline. Therefore, it is beneficial to preemptively limit the power of the fuel cell stack 300 and thus the first calibration value may be set to Cₖ₄ (e.g., 0.7). However, this is an example, the first calibration value may be adjusted according to the degree of occurrence of the cell voltage decline phenomenon, and the concept of specific values and set ranges may vary depending on the system configuration or specifications of the fuel cell stack 300, and thus settings according to tuning of a tester may be required.

The first power value indicated on the x-axis of the graph of FIG. 7 may be viewed as a power value corresponding to a lower limit of a low power range based on maximum stack power for determining the cell voltage decline phenomenon because the cell voltage decline phenomenon can be determined if the stack outputs a certain level of power, and the second power value may be a reference value for obtaining reliability of the cell voltage decline phenomenon based on the maximum power of the fuel cell stack 300. Further, the range between the first power value and the second power may be divided and set according to precision and effectiveness from dividing the range.

The first reference value indicated on the y-axis of the graph of FIG. 7 refers to a reference value for a normal degree of occurrence of the cell voltage decline phenomenon and may be set as the number of occurrences of the cell voltage decline phenomenon within a normal range if power is generated from the fuel cell stack 300. The second reference value may be a value set by measuring a degree of occurrence of the cell voltage decline phenomenon based on the fuel cell stack 300 that is close to EoL (End of Life) and back-estimating a degree of occurrence at EoL. The range between the first and second reference values may also be divided and set according to precision and effectiveness from dividing the range.

The first calibration value described herein may be stored in a separate memory provided in the controller 500, for example in the form of a data map.

As described herein, if the SoH of the fuel cell stack 300 is between the first reference state SoH₁ and the second reference state SoH₂, the power weighting coefficient K may be varied by reflecting the first calibration value in 1, and accordingly, the graph of FIG. 6 may be changed to the graph shown in FIG. 8.

Hereinafter, the compensation coefficient R according to an example of the present disclosure will be described with reference to FIG. 5 and FIG. 9 to FIG. 11.

The compensation coefficient R according to an example of the present disclosure may increase as the SoH of the fuel cell stack 300 increases if the SoH of the fuel cell stack 300 is greater than or equal to the preset first reference state SoH₁ (Yes in S531 and S561). Also, or alternatively, the compensation coefficient R may be 0 if the SoH of the fuel cell stack 300 is less than the preset first reference state SoH₁ (No in S531, S562, S563, and S564).

In the present disclosure, the compensation coefficient R is reflected to determine the power adjustment value according to SoH. The compensation coefficient R is an indicator that is set if it is determined that additional power is required for an adjustment proportion determined depending on the performance of the fuel cell stack 300, and can create the effect of expanding the area in which the fuel cell stack 300 is used in the entire system if the SoH of the fuel cell stack 300 is high (e.g., SoH is greater than or equal to the first reference state). By using this indicator, if the performance of the fuel cell stack 300 is high, the amount of variation in battery energy (e.g., the amount of variation in SoC) can be reduced and improvement of battery lifespan is anticipated. For example, referring to FIG. 9, the maximum value of the compensation coefficient R may be set experimentally if the SoH is 100% and may be proportionally adjusted if the SoH is between the first reference state SoH₁ and 100%.

Meanwhile, the compensation coefficient R may vary depending on the power amount of the fuel cell stack 300 or the SoH of the fuel cell stack 300 in a specific SoH range of the fuel cell stack 300. The compensation coefficient R may vary based on 0 depending on the power amount of the fuel cell stack 300 or the SoH of the fuel cell stack 300 if the SoH of the fuel cell stack 300 is less than the first reference state SoH₁ (No in S531) and is between the second reference state SoH₂ lower than the first reference state SoH₁ and the third reference state SoH₃ lower than the first reference state SoH₁ and higher than the second reference state SoH₂ (S532 and S533). Since the third reference state SoH₃ has been described in detail with reference to FIG. 2, description thereof will be omitted hereinafter.

If the SoH of the fuel cell stack 300 is between the second reference state SoH₂ and the third reference state SoH₃ (Yes in S533), the controller 500 may determine that there is a risk of the lifespan of the fuel cell stack 300 being reduced and provide a lifespan reduction warning notification (S542). Then, the controller 500 may determine the SoC of the battery 100, and if the determined SoC of the battery 100 is equal to or less than a reference SoC (Yes in S550), vary the compensation coefficient R such that the compensation coefficient R increases as the SoH decreases based on 0 (S563). For example, the compensation coefficient R may be varied based on a second calibration value determined according to the power amount of the fuel cell stack 300 or the SoH of the fuel cell stack 300.

If the SoH decreases equal to or less than the third reference state SoH₃, which is lower than the first reference state SoH₁ and higher than the second reference state SoH₂, it can be determined that the fuel cell stack 300 has deteriorated and the performance thereof has declined. The third reference state SoH₃ may refer to a state in which the fuel cell stack 300 has irreversibly deteriorated and cannot be recovered, as described above with reference to FIG. 2. If the fuel cell stack 300 reaches this state, even if the power distribution proportion is controlled by the preceding logic, the fuel cell stack 300 fails to produce the intended power, resulting in an unexpected power decrease and an unintended actual power reduction compared to the system required power. In this situation, it may be necessary to determine that the durability of the fuel cell stack 300 has declined to the limit, and to ensure driving power and guide the user to a repair shop for driving stability. Also, or alternatively, the user may be caused to receive maintenance by notifying the user through a warning that the lifespan of the fuel cell stack 300 has been reduced (S410).

The present disclosure proposes an additional logic for supplementing the power proportion of the fuel cell stack 300 due to SoH decrease in order to complement situations where power decreases. If all of conditions below are satisfied, upon determining that the performance durability limit of the fuel cell stack 300 has been reached, entry to power error compensation control according to a power output error of the fuel cell stack 300 may be determined.
Condition 1: Third reference state≥SoH>second reference state
Condition 2: Battery reference SoC≥current battery SoC

Condition 2 above is a condition for determining if the SoC of the battery 100 is equal to or less than a certain level. If this condition is satisfied, this means that the battery 100 can recharge additional energy (energy generated from the fuel cell stack or regenerated from the motor). If the current SoC of the battery 100 exceeds the reference SoC, the SoC of the battery 100 is consumed and required power of the fuel cell system may be handled even if the fuel cell stack 300 does not produce the performance corresponding to the power proportion (S420).

If all of the above conditions are satisfied, the reaction performance of the fuel cell stack 300 may decline and thus the actual power may decrease compared to target power. The present disclosure proposes control of improving a target through compensation control above a certain level than the previous target power in that case. However, as described above, if the target power of the fuel cell stack 300 is improved, unintended additional power of the fuel cell stack 300 may be generated beyond insufficient power compensation, and thus operation may be performed only if the SoC of the battery 100 is below a certain level in order to prevent the voltage of the high voltage stage from increasing.

If the SoH is equal to or less than the third reference state SoH₂, an additional second calibration value is reflected in the indicator for each consumption power range of the fuel cell stack 300 to reflect generation of a power error of the fuel cell stack 300. If additional power of the fuel cell stack 300 is required according to the operation strategy (for example, if the dynamic performance of the system is ahead of the durability of the fuel cell stack) in a range in which the SoH is reduced, the compensation coefficient may be calibrated using the second calibration value in order to calibrate the power through an additional compensation value.

The second calibration value will be described in detail with reference to FIG. 10.

As shown in FIG. 10, a second calibration value according to SoH change (third reference state≥SoH>second reference state) may be determined for each power range of the fuel cell stack 300 to reflect [stack power error compensation value]. The second calibration value is a value for additional calibration in determining the compensation coefficient R, and since the power proportion is directly reflected according to the second calibration value, this value needs to be determined by gradually increasing the same experimentally.

As shown in FIG. 10, each of CR1 to CR7 may be the second calibration value classified depending on the power and SoH of the fuel cell stack 300. Also, or alternatively, the second calibration value may increase as the power amount of the fuel cell stack 300 increases or the SoH of the fuel cell stack 300 decreases, and the relationship of CR1<CR2<CR3<CR4<CR5<CR6<CR7 may be established.

For example, as the power consumption of the fuel cell stack 300 increases, the absolute value of power error increases, and thus the second calibration value is determined to be large. As the power consumption of the fuel cell stack 300 decreases, the absolute value of power error decreases, and thus the second calibration value is determined to be small. Also, or alternatively, as the SoH increases, the second calibration value may be determined to be small since the performance of the fuel cell stack 300 is high. As the SoH decreases, the second calibration value may be determined to be large since the performance of the fuel cell stack 300 is low.

Also, or alternatively, if the power consumption of the fuel cell stack 300 is low, the overall power is low, and thus power shortage error is insignificant and power can be compensated to some extent by the battery 100 without increasing the power of the fuel cell stack 300. Therefore, the second calibration value may be determined to be small. If the power handled by the fuel cell stack 300 is high, power shortage error increases and power fluctuation may occur as a result, and thus a power reference value of the fuel cell stack 300 may be set to be high. Also, or alternatively, as the SoH decreases, the performance of the fuel cell stack 300 declines and dynamic performance rather than durability is required, that is, long driving to a repair shop is required, and thus the second calibration value may be determined to be large. Also, or alternatively, as the SoH increases, the performance of the fuel cell stack 300 is high within the corresponding range, and thus even if the second calibration value is determined to be small, the effect on drivability may be small.

Meanwhile, the third power value indicated on the x-axis of the graph of FIG. 10 may be set as a point in time when power shortage error begins to occur greater than or equal to a certain level. Also, or alternatively, the fourth power value may be set to a value that is determined to be necessary for possible compensation by increasing a reference value even if the power shortage error is significant and a consumption power reference value of the fuel cell stack 300 is maximized. For example, the fourth power value can be applied if the SoH is lowered and drivability is more important than durability. The range between the third power value and the fourth power value may be divided according to precision and effectiveness when dividing the range.

The fourth reference state disclosed on the y-axis of the graph of FIG. 10 may be determined as a point in time when operability is determined to be more important than management of the SoH (this is determined depending on system operation and marketability). Also, or alternatively, the fifth reference state corresponds to a range in which power shortage error is insignificant, the SoH is at a certain high level, and power consumption is low and may be set as a reference value for maintaining stable control rather than compensation. The range between the fourth and fifth reference states may also be divided depending on precision and effectiveness when dividing the range.

Also, or alternatively, the above-described second calibration value may be stored in a separate memory provided in the controller 500 in the form of a data map.

As described above, if the SoH of the fuel cell stack 300 is between the second reference state SoH₂ lower than the first reference state SoH₁ and the third reference state SoH₃ lower than the first reference state SoH₁ and higher than the second reference state SoH₂ (Yes in S533), the compensation coefficient R may be varied by reflecting the second calibration value based on 0 (S563) (e.g., varied from 0, varied around 0, varies relative to 0), and accordingly, the graph of FIG. 9 may be changed to the graph shown in FIG. 11.

Referring back to FIG. 5, when the power weighting coefficient K and the compensation coefficient R according to the SoH of the fuel cell stack 300 are determined (S561 to S564), the controller 500 may calculate a power adjustment value based on the determined power weighting coefficient K and compensation coefficient R (S570). Then, the controller 500 may calculate a final power proportion by calibrating the required power proportion based on the calculated power adjustment value, and control power generation of the fuel cell stack 300 based on the calculated final power proportion (S580).

The present disclosure provides a fuel cell system and a method of controlling the same to optimize power distribution for an entire fuel cell vehicle and manage an SoH in advance by applying a control technique for previously calibrating/limiting a required power amount of a stack in the fuel cell vehicle and preventing continuous SoH decline by using SoH information in order to improve power errors caused by decrease in stack power of the fuel cell vehicle or the like.

In accordance with an aspect of the present disclosure, the above and other objects can be accomplished by the provision of a fuel cell system including a battery and a fuel cell stack each outputting electrical energy to satisfy final required power, and a controller configured to calculate a required power proportion of the fuel cell stack to satisfy the final required power, to calculate a final power proportion of the stack by calibrating the required power proportion of the fuel cell stack using a power adjustment value (e.g., variable) depending on a state of health (SoH) of the fuel cell stack to, and to control power generation of the fuel cell stack according to the calculated final power proportion.

In accordance with another aspect of the present disclosure, there is provided a method of controlling a fuel cell system including a battery, a fuel cell stack, and a controller, the method including calculating, by the controller, a required power proportion of the fuel cell stack to satisfy final required power, calculating, by the controller, a power adjustment value (e.g., variable) depending on a state of health (SoH) of the fuel cell stack, calculating, by the controller, a final power proportion of the fuel cell stack by calibrating the required power proportion of the fuel cell stack according to the calculated power adjustment value, and controlling, by the controller, power generation of the fuel cell stack according to the final power proportion.

According to the fuel cell system and the method of controlling the same of the present disclosure, the stack performance indicator can be used as a factor determining the ratio of stack required power to battery required power, and a decrease in stack available power can be preemptively predicted to readjust and determine the ratio of stack power to battery power.

In situations where the performance of the stack declines, it is possible to prevent a decrease in vehicle driving power and unexpected vehicle shaking from the perspective of the overall vehicle energy.

Depending on the stack performance status, control for actively using or compensating for the stack is performed, thereby maximizing utilization of the stack in a fuel cell vehicle.

By using the stack performance indicator, it is possible to determine that the performance of the stack has declined to an irrecoverable level and to determine failure code and vehicle power limitation strategy, and accordingly it is possible to determine the performance decline of the stack, operate the vehicle with limited power, and check stack replacement timing.

According to the fuel cell system and the method of controlling the same of the present disclosure described above, the stack performance indicator is used as a factor determining the ratio of stack required power to battery required power, and a decline in stack available power can be preemptively predicted to readjust and determine the ratio of the power of the stack and the power of the battery.

In situations where the performance of the stack declines, it is possible to prevent a decrease in vehicle driving power and unexpected vehicle shaking from the overall vehicle energy perspective.

Depending on the stack SoH, control is performed to actively use or compensate for the stack, thereby maximizing the use of the stack in a fuel cell vehicle.

By using the stack performance indicator, it is possible to determine that the performance of the stack has declined to an irrecoverable level and determine a failure code and a vehicle power limitation strategy, and accordingly, it is possible to determine performance decline of the stack, operate the vehicle with limited power, and check stack replacement timing.

Although the preferred examples of the present disclosure have been disclosed for illustrative purposes, those skilled in the art will appreciate that various modifications, additions and substitutions are possible, without departing from the scope and spirit of the present disclosure as disclosed in the accompanying claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various examples of the present disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In examples of the present disclosure, “at least one of A and B” may refer to “at least one of A or B” or “at least one of combinations of one or more of A and B”. Also, or alternatively, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the claims appended hereto and their equivalents.

What is claimed is:

1. A fuel cell system comprising:
a battery configured to output a first electrical energy;
a fuel cell stack configured to output a second electrical energy, wherein a total of the first electrical energy and the second electrical energy satisfies a final required power; and
a controller configured to:
determine a required power proportion of the fuel cell stack to satisfy the final required power;
determine a final power proportion of the fuel cell stack by calibrating, based on a power adjustment value depending on a state of health (SoH) of the fuel cell stack, the required power proportion of the fuel cell stack; and
control, based on the determined final power proportion, power generation of the fuel cell stack.

2. The fuel cell system of claim 1, wherein the controller is configured to:
calibrate the required power proportion by multiplying the required power proportion of the fuel cell stack by the power adjustment value; and
determine the final power proportion based on the calibrated required power proportion.

3. The fuel cell system of claim 1, wherein the power adjustment value is further depending on at least one of:
a power generation amount of the fuel cell stack, or
a degree of short-term performance decline of the fuel cell stack.

4. The fuel cell system of claim 1, wherein the power adjustment value is determined using the following formula:
$$p ower adjustment value = 1 - power weighting coefficient \times ( 1 - \frac{SoH}{100} ) + compensation coefficient ,$$
wherein the power weighting coefficient and the compensation coefficient are each determined based on the SoH.

5. The fuel cell system of claim 4, wherein the power weighting coefficient is set to 0 based on the SoH of the fuel cell stack being greater than or equal to a first reference state.

6. The fuel cell system of claim 4, wherein, if the SoH of the fuel cell stack is equal to or less than a second reference state less than a first reference state, the power weighting coefficient is determined according to the following formula:
$$p ower weighting coefficient = \frac{100}{100 - SoH} .$$

7. The fuel cell system of claim 4, wherein the power weighting coefficient is 1 while the SoH of the fuel cell stack is between a first reference state and a second reference state lower than the first reference state.

8. The fuel cell system of claim 4, wherein, while the SoH of the fuel cell stack is between a first reference state and a second reference state lower than the first reference state, the power weighting coefficient is determined based on a first calibration value determined depending on a power amount or a degree of short-term performance decline of the fuel cell stack.

9. The fuel cell system of claim 8, wherein the first calibration value decreases with increase of one or more of the power amount of the fuel cell stack or the degree of short-term performance decline of the fuel cell stack.

10. The fuel cell system of claim 9, wherein the degree of short-term performance decline is based on a voltage level of an individual fuel cell of the fuel cell stack.

11. The fuel cell system of claim 4, wherein, while the SoH is above a first reference state, the compensation coefficient increases with increase of the SoH.

12. The fuel cell system of claim 4, wherein, while the SoH of the fuel cell stack is below a first reference state, the compensation coefficient is0.

13. The fuel cell system of claim 12, wherein, while the SoH of the fuel cell stack is between a second reference state, lower than the first reference state, and a third reference state, lower than the first reference state and higher than the second reference state:
a state of charge (SoC) of the battery is determined; and
while the determined SoC of the battery is equal to or less than a reference SoC, the compensation coefficient increases from 0 with decrease of the SoH of the fuel cell stack.

14. The fuel cell system of claim 13, wherein the compensation coefficient is based on a second calibration value determined according to one or more of a power amount of the fuel cell stack or the SoH of the fuel cell stack.

15. The fuel cell system of claim 14, wherein the second calibration value increases with increase of the power amount of the fuel cell stack or with decrease of the SoH of the fuel cell stack.

16. The fuel cell system of claim 1, wherein the controller is configured to calibrate the required power proportion of the fuel cell stack based on a change rate of the SoH of the fuel cell stack being greater than or equal to a reference change rate.

17. A method comprising:
determining, by a controller of a fuel cell system comprising a fuel cell stack and a battery, a required power proportion of the fuel cell stack to satisfy, with a power proportion from the battery, a final required power;
determining, by the controller based on a state of health (SoH) of the fuel cell stack, a power adjustment value;
determining, by the controller, a final power proportion of the fuel cell stack by calibrating the required power proportion of the fuel cell stack based on the determined power adjustment value; and
controlling, by the controller and based on the final power proportion, power generation by the fuel cell stack.
